(19) United States
(12) Patent Application Publication
(10) Pub. No.: US 2018/0347903 A1
(43) Pub. Date: Dec. 6, 2018

(54) SYSTEM AND METHOD FOR DRYING WOOD ITEMS FOR THE AGRICULTURE-FOODSTUFFS INDUSTRY

(71) Applicant: SMART WOOD, Saint-Sauveur (FR)

(72) Inventors: Frédéric DEBACKER, Compiegne (FR); Olivier MORIN, Paris (FR)

(21) Appl. No.: 15/995,227

(22) Filed: Jun. 1, 2018

(30) Foreign Application Priority Data
Jun. 2, 2017 (FR) 1754952

(51) Int. Cl. F26B 15/18; F26B 3/30; F26B 25/22

(52) U.S. Cl. CPC F26B 15/18; F26B 3/30; B27L 9/00; F26B 2210/16; F26B 25/22

(57) ABSTRACT

A system for drying wood items for the agriculture-foodstuffs industry ensuring effective and economical tracking of the items produced comprises at least three conveyors arranged in such a manner as to constitute a closed circuit of conveyors to provide cyclic circulation of items disposed on these conveyors, at least two of the conveyors being inclined in such a manner that, in use, the items drop from one conveyor onto another, an exit conveyor that can be activated in a selective manner at a downstream end of one of the conveyors of the closed circuit in such a manner as to allow, when it is activated, the items to exit from the closed circuit, a plurality of vibrators adapted to cause the conveyors to vibrate, and heating means above the conveyors to dry the items deposited on the conveyors.

The present invention relates to a system and to a method for drying wood items for the agriculture-foodstuffs industry, such as lollipop sticks, forks, knives, spoons, spatulas for stirring drinks and toothpicks. By wood is meant tree wood, but also the stems of plants such as bamboo.

These items are of small size, that is to say of the order of 5 to 20 cm long, 0.5 to 3 cm wide, and 0.1 to 0.6 cm thick, plus or minus 15%.

The tree wood items are obtained by tangentially cutting rotating wood balls to unwind a sheet of wood a few millimetres thick, usually between 0.1 and 0.6 cm thick. This sheet is then cut by hollow punches of defined shape to obtain blanks of the required items that are to undergo treatments, notably drying, before obtaining the finished product.

Bamboo items are generally obtained by longitudinally cutting portions of bamboo to obtain blanks of the required articles that have to undergo treatments, notably drying, before obtaining the finished product.

At present drying is carried out in large rotary steam drums provided with an entry for moist items and an exit for dried items. Between the entry and the exit the drum comprises steam feeds and a sheetmetal Archimedes screw guide to force the items to advance toward the exit.

In order to make the drying of the items cost effective, the drums are generally of large size to be able to dry the equivalent of the production of product blanks in an entire day (12 hours). Moreover, the drums are fed continuously. Accordingly, a drum contains mixtures of item blanks from different batches of trees or plants.

Finally, given human imperatives, the drying drums are operated during the working day, so that they contain a portion (often half) of the production of the day before and a portion (often half) of the production of the same day.

It is therefore not possible at present to make the items traceable, that is to say that it is not possible to be sure that in a box of finished products all the items come from the same identified batch of trees or plants.

Now, production quality requirements demand the ability to ensure the traceability of the products, that is to say the ability to be able to determine from which batch of trees or plants a particular item comes. This is useful in the case of detection of defects so as to be able to remove all the items coming from a defective batch for example. At present, in the absence of such traceability, it is the production of two days (the day before and the same day) that may need to be destroyed whereas it would have sufficed to discard only a few boxes of items coming from only one batch.

The present invention therefore aims to propose a drying system providing for tracing the items produced.

The prior art drums are also used to polish and to wax the items. Accordingly, thanks to the rotation of the drum, the items rub against one another, which enables the items to polish one another. After a particular time soluble liquid paraffin wax is introduced into the drum which is then rotated again to provide the waxing (complete coating of each product with paraffin wax) of all the products present in the drum.

However, because of the large quantity of items and their weight, agitation of the items by rotating the complete drum generates a large number of breakages and therefore of losses that can be detected only at the end of the cycle.

Over and above the lost raw material, this also generates losses of paraffin wax as the latter is applied to all the products in the drum, including the broken products.

The present invention therefore aims to propose a drying system that is more effective in limiting breakages and more economical in limiting the losses of paraffin wax.

Finally, these drums being steam operated, a steam generation system must be associated with the drums. These systems consume both energy and water.

The present invention therefore aims to propose a drying system that is more economical, in particular in terms of water consumption.

To this end, the invention consists in a system for drying wood items for the agriculture-foodstuffs industry comprising:
at least three conveyors arranged in such a manner as to constitute a closed circuit of conveyors to provide, in use, cyclic circulation of items disposed on these conveyors, at least one of the conveyors being inclined in such a manner that, in use, the items drop from one conveyor onto another;
a so-called “exit” conveyor that can be activated in a selective manner at a downstream end of one of the conveyors of the closed circuit in such a manner as to allow, when it is activated, the items to exit from the closed circuit;
a plurality of vibrators adapted to cause the conveyors to vibrate in a direction substantially perpendicular to a longitudinal direction of the rigid chute conveyors with a defined frequency and a defined amplitude of vibration;
heating means above the conveyors of the closed circuit to dry, in use, the items deposited on the conveyors.

According to particular embodiments:
the vibrators may have an adjustable frequency and amplitude of vibration;
the conveyors may be chosen from belt conveyors, rigid chute conveyors and a mixture thereof;
the closed circuit of conveyors may comprise:
   a rigid chute first conveyor and a rigid chute second conveyor oppositely inclined and therefore each having, in a position of use and relative to the direction of movement of the items, a low upstream end and a high downstream end;
   a belt third conveyor arranged between the high downstream end of the rigid chute first conveyor and the low upstream end of the rigid chute second conveyor;
   a belt fourth conveyor arranged between the high downstream end of the rigid chute second conveyor and the low upstream end of the rigid chute first conveyor;
the vibrators being adapted also to generate a vibration in a direction substantially parallel to a longitudinal direction of the rigid chute conveyors with a defined frequency and a defined amplitude of vibration;
the closed circuit of conveyors may comprise:
   a belt first conveyor and a belt second conveyor inclined oppositely and each therefore having, in the position of use and relative to the direction of movement of the items, a low upstream end and a high downstream end;
   a belt third conveyors arranged between the high downstream end of the belt first conveyor and the low upstream end of the belt second conveyor;
   a belt fourth conveyor arranged between the high downstream end of the belt second conveyor and the low upstream end of the belt first conveyor;
the belt third and fourth conveyors may also be oppositely inclined so that during a cycle each item drops four times;
the drying system may further comprise:
   a sensor of the moisture content of the items disposed on the conveyors;
   a central unit connected to the moisture sensor and programmed:
      to compare a moisture content value transmitted by the moisture sensor to a moisture content threshold value;
      to command activation of the exit conveyor if the moisture content value transmitted by the moisture sensor is less than or equal to the moisture content threshold value;
the central unit may also be connected to a timer and to the heating means, the central unit being programmed:
   to time a time of presence of the items on the closed circuit of conveyors;
   to control the heating means as a function of the moisture content value transmitted by the moisture sensor and the time of presence transmitted by the timer in order to regulate a drying time of the items;
the central unit may also be connected to the vibrators, the central unit being programmed to control the frequency and/or a defined amplitude of vibration of the vibrators as a function of the moisture content value transmitted by the moisture sensor;
the conveyors of the closed circuit may be belt conveyors, the central unit being also connected to drive motors of the belt conveyors and programmed to control a drive speed of the belt conveyors as a function of the moisture content value transmitted by the moisture sensor;
the drying system may further comprise a feeder conveyor arranged at an upstream end of one of the conveyors of the closed circuit to feed said closed circuit with items to be dried;
the heating means may comprise a bank of infrared lamps;
the drying system may further comprise at least one ambient air aspiration means;
the aspiration means may be situated beside and near the conveyors;
the conveyors may be belt conveyors the belts of which are perforated and the aspiration means is situated under the belt of the belt conveyors relative to the items;
the conveyors may be belt conveyors the belts of which are perforated and constituted of a metal mesh;
the conveyors may be perforated rigid chute conveyors and the aspiration means is situated under the rigid chute conveyors relative to the items;
and/or
the rigid chute conveyors may be constituted of a metal mesh.

The invention also consists in a method for drying wood items for the agriculture-foodstuffs industry using the above drying system, comprising the following steps:
A) arranging at least three conveyors in such a manner as to constitute a closed circuit of conveyors to provide, in use, cyclic circulation of items disposed on these conveyors, at least one of the conveyors being inclined in such a manner that, in use, the items drop from one conveyor onto another;
B) arranging a so-called “exit” conveyor that can be activated in a selective manner at a downstream end of one of the conveyors of the closed circuit in such a manner as to allow, when it is activated, the items to exit from the closed circuit;
C) arranging a plurality of vibrators to cause the conveyors to vibrate, in use, with a defined frequency and a defined amplitude of vibration;
D) arranging heating means above the conveyors to dry, in use, the items deposited on the conveyors;
E) actuating the vibrators and the conveyors of the closed circuit;
F) actuating the heating means;
G) feeding one of the conveyors of the closed circuit of conveyors with a defined quantity of items to be dried;
H) allowing the items to be dried to circulate on the closed circuit of conveyors for a number of cycles sufficient for the items to reach a threshold moisture content;
J) activating the exit conveyor in such a manner as to allow the dried items to exit from the closed circuit.

Other features of the invention are stated in the following detailed description given with reference to the appended drawings, which respectively show:

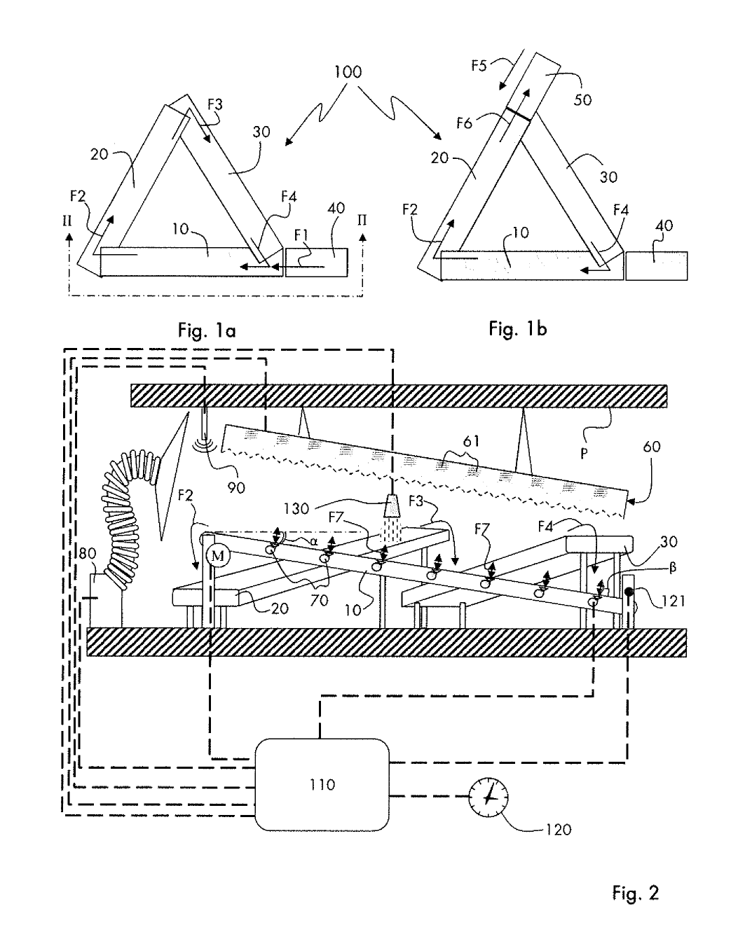

FIGS. 1a and 1b, diagrammatic plan views seen from above of a first embodiment of a drying system according to the invention during drying and at the end of drying;

FIG. 2, a partial diagrammatic plan view as seen from the side of the drying system according to the invention from FIG. 1a, showing a belt conveyor equipped with vibrators and a heating means;

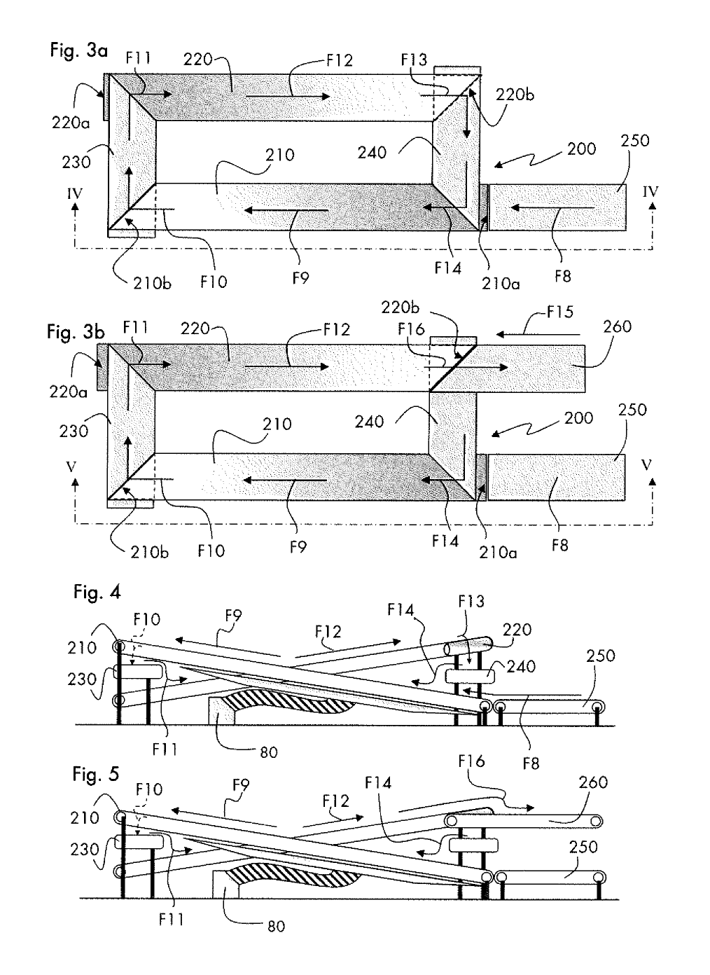

FIGS. 3a and 3b, diagrammatic plan views seen from above of a second embodiment of a drying system according to the invention during drying and at the end of drying;

FIG. 4, a diagrammatic plan view seen from the side of the drying system according to the invention from FIG. 3a;

FIG. 5, a diagrammatic plan view seen from the side of the drying system according to the invention from FIG. 3b;

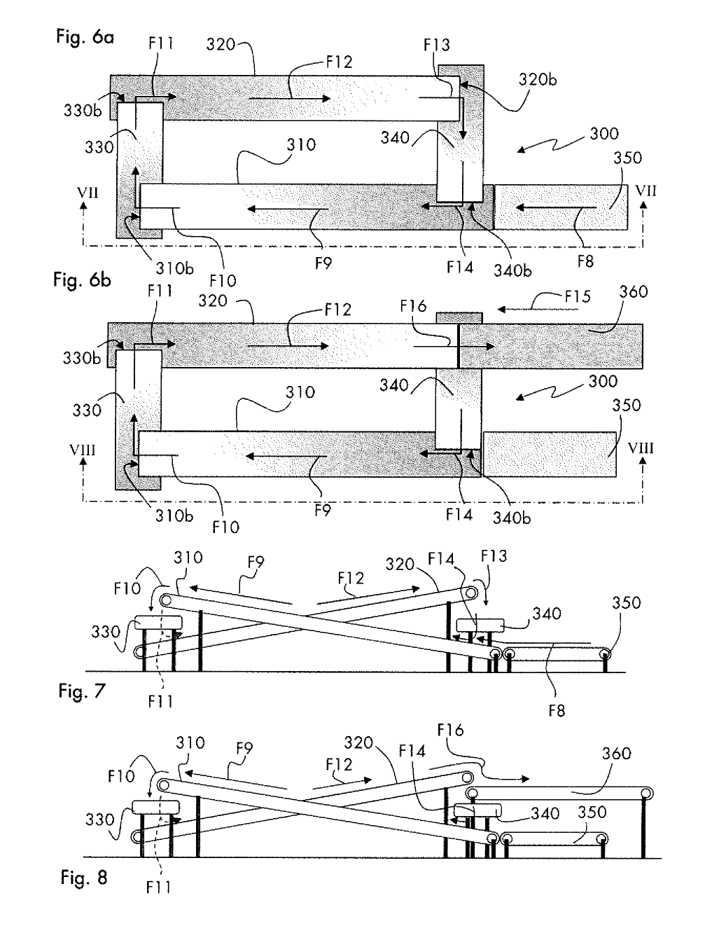

FIGS. 6a and 6b, diagrammatic plan views seen from above of a third embodiment of the drying system according to the invention during drying and at the end of drying;

FIG. 7, a diagrammatic plan view seen from the side of the drying system according to the invention from FIG. 6a;

FIG. 8, a diagrammatic plan view seen from the side of the drying system according to the invention from FIG. 6b;

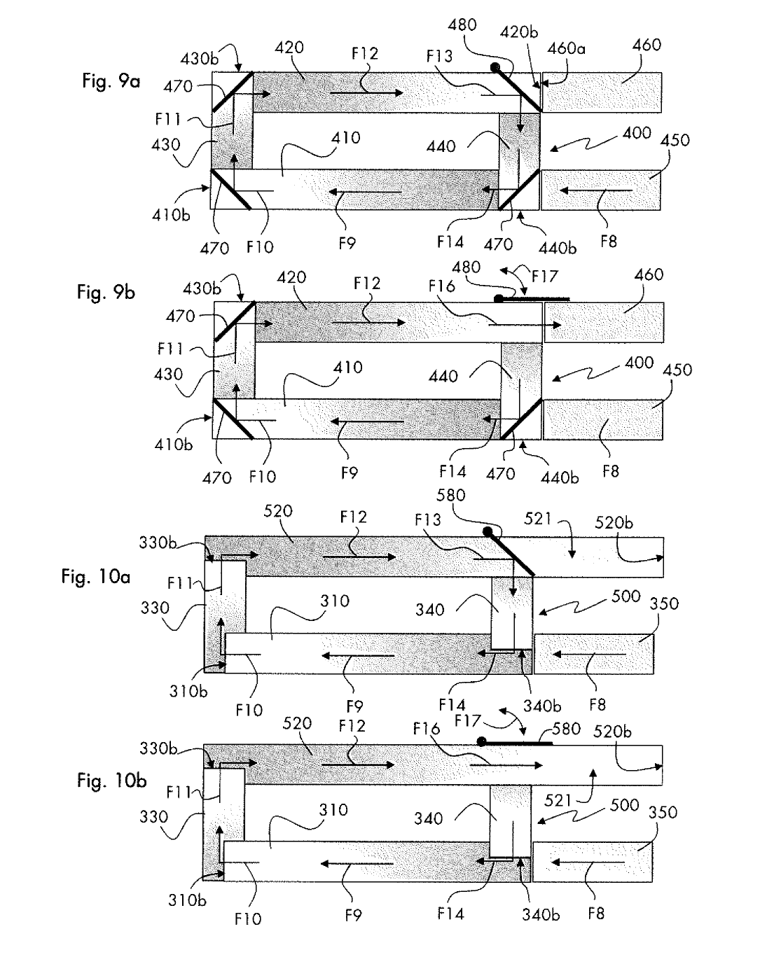

FIGS. 9a and 9b, diagrammatic plan views seen from above of a fourth embodiment of a drying system according to the invention during drying and at the end of drying;

FIGS. 10a and 10b, diagrammatic plan views seen from above of a variant of the embodiment from FIGS. 6a and 6b provided with deflectors; and

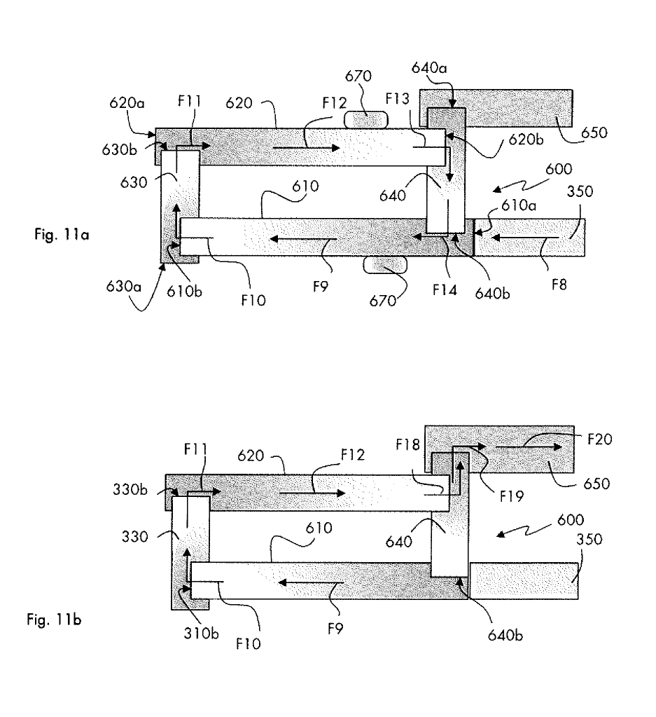

FIGS. 11a and 11b, diagrammatic partial plan views seen from above of a fifth embodiment of the invention comprising reversible belt conveyors and rigid chute conveyors during drying and at the end of drying.

FIG. 1 shows a first embodiment of a system 100 according to the invention for drying wood items for the agriculture-foodstuffs industry.

The system 100 comprises three belt conveyors 10, 20, 30 arranged in such a manner as to constitute a closed circuit of conveyors. Alternatively, the conveyors may be rigid chute conveyors, as explained with reference to FIG. 11. As shown hereinafter, the number of conveyors may be greater, what is important is to be able, for a particular time, to circulate items to be dried in a closed circuit. Accordingly, when the products are disposed on the conveyors of the closed circuit they circulate in a cyclic manner.

The items are advantageously fed by a feeder belt conveyor 40 in the direction of the arrow F1 until a defined number of items have been fed onto the conveyor 10. The feeder conveyor 40 is then stopped.

During each cycle, the items pass from the belt conveyor 10 to the belt conveyor 20 in the direction of the arrow F2 and then to the belt conveyor 30 in the direction of the arrow F3.

The items then return to the conveyor 10 in the direction of the arrow F4.

When the items are dry (FIG. 1b), a so-called “exit” belt conveyor 50 is activated. In this embodiment, to be activated, the belt conveyor 50 is positioned in the direction of the arrow F5 at a downstream end of one of the belt conveyors of the closed circuit, here the conveyor 20, to interrupt the closed circuit and, when activated, to allow items to exit the closed circuit in the direction of the arrow F6.

The exit conveyor 50 is advantageously connected to the remainder of the treatment circuit to finish the fabrication of the items.

As shown in FIG. 2, a heating means 60 is arranged above the belt conveyors 10, 20 and 30 to dry the items disposed on the belt conveyors. In the embodiment shown the heating means is constituted of a bank of infrared lamps 61 suspended from the ceiling P.

According to the invention, at least one of the conveyors 10, 20 and 30 is inclined so that, in use, items drop from one conveyor onto another (in the direction of the arrows F2, F3 and F4). This dropping mixes the items, which rub against one another.

The belt conveyors are preferably arranged so that the items drop between two consecutive belt conveyors.

This enables both improved distribution of the heat emitted by the heating means 60 but also polishing of the items by rubbing on one another.

To improve these two phenomena (heat distribution and polishing) the invention provides a plurality of vibrators 70 arranged in such a manner as to cause the belts of the belt conveyors to vibrate in a direction F7 substantially perpendicular (the angle β is substantially equal to) 90° to a longitudinal direction F9, F12 of the conveyors with a defined frequency and a defined amplitude of vibration. This vibration is transmitted to the items, which skip around on the belt. These movements allow the items to rub against one another, thus enabling mutual polishing, and to pivot and to turn over on the belt, thereby homogenizing drying.

The vibrators 70 advantageously have adjustable vibration amplitude and frequency.

The system advantageously also comprises at least one ambient air aspiration means 80. A system of this kind enables aspiration of the moisture given off the heating means drying the items, but also aspiration of the dust generated by the mutual rubbing of the items as they circulate on the belt conveyors and are dropped and vibrated.

In the embodiment shown in FIG. 2, the aspiration means 80 is situated beside and near the belt conveyors 10, 20, 30.

Alternatively or additionally, as shown in FIGS. 4 and 5, the aspiration means 80 may be situated under the belt of the belt conveyors relative to the items to aspirate dust generated by the mutual rubbing of the items when they circulate on the belt conveyors.

In this case, the belts of the belt conveyors are advantageously perforated to allow the passage of air. For example, the belts are constituted of a metal, preferably stainless steel mesh.

The drying system according to the invention preferably comprises at least one sensor 90 for sensing the moisture content of the items disposed on the belt conveyors. This sensor is for example an infrared sensor capable of giving information concerning the moisture content of the items circulating on the belt conveyors.

An operator can therefore measure the moisture content of the items and decide if they must continue to circulate in a closed circuit on the belt conveyors 10, 20, 30 under the heating means 60 or if the exit belt conveyor 50 should be activated to evacuate the sufficiently dry items.

In an advantageous embodiment of the invention the drying system is automatically controllable by a central unit 110.

The central unit 110 is connected to the moisture sensor 90 and is programmed to compare a moisture content value transmitted by the moisture sensor 90 to a threshold value that is predetermined or defined by the operator as a function of what is required.

It is also programmed to command activation of the exit belt conveyor 50 if the moisture content value transmitted by the moisture sensor 90 is less than or equal to the threshold value.

Activation of the exit belt conveyor 50 is, depending on the configuration of the closed circuit of belt conveyors (number of conveyors, arrangement), either merely starting up or movement to a position of use followed by starting up.

The drying of the wood items depends in particular on the heat transmitted by the heating means and the time of exposure of the items to the heat. For example, it may therefore be preferable (depending on the wood species, the dimensions or the type of the items) to apply medium heat for a long time rather than intense heat for a short time.

The central unit 110 is advantageously also connected to a timer 120 and to the heating means 60.

The timer 120 is preferably connected to a sensor 121 of the presence of items on the belt first conveyor 10 to start the timer as soon as the items arrive in the closed circuit of belt conveyors.

The central unit 110 is therefore programmed to time the presence of the items in the closed circuit of belt conveyors and to control the heating means 60 as a function of the moisture content value transmitted by the moisture sensor 90 and the time of presence transmitted by the timer 120, in order to regulate the item drying time.

Controlling the heating means 60 entails increasing or decreasing its power. The heating means is therefore adjustable in this case.

As a function of the moisture content of the items detected by the moisture sensor 90, the central unit 110 can then, for example, increase the power of the heating means 60 if the drying time is too long.

Alternatively, or additionally, the central unit 110 may be connected to the drive motors M of the belt conveyors to accelerate them or to reduce their speed in order to increase or to decrease the duration of a circulation cycle, that is to say to increase or to decrease the time necessary for an item to travel over all the belt conveyors 10, 20, 30.

Alternatively, or additionally, the central unit 110 may also be connected to the vibrators 70. In this case the central unit 110 is programmed to control the frequency and/or the amplitude of vibration of the vibrators 70 as a function of the moisture content value transmitted by the moisture sensor 90.

In this way the central unit can favour or not the homogenization of the heat around each item.

The drying system according to the invention advantageously further comprises nozzles 130 for spraying solid or liquid paraffin wax onto the items disposed on the belt conveyors.

The central unit 110 is preferably also connected to the paraffin wax spray nozzles 130, the central unit 110 being programmed to control the spraying of paraffin wax as a function of the moisture content value transmitted by the moisture sensor 90.

The heating, drive motor speed, frequency and/or amplitude, air aspiration parameters may also vary as a function of time in accordance with a pre-programmed curve. For example, the heating power may be high for a particular time, then lower, then high again. Likewise, the speed of the belt conveyors may be moderate at the beginning and then higher toward the end of the treatment. Likewise, the frequency and/or the amplitude of vibration may be low at the beginning and then higher toward the end of the treatment when the items are drier and therefore less heavy.

The system according to the invention therefore enables a high level of multipurpose treatment as a function of the items and therefore of the batches of raw material from which they were made. It is then possible to treat batches with very different properties during the day, whilst ensuring their traceability.

The heating means, the sensors and the vibrators are not shown in FIGS. 3a to 10b for clarity.

FIGS. 3a and 3b show a second embodiment in which the closed circuit of belt conveyors of the system 200 comprises a belt first conveyor 210 and a belt second conveyor 220, oppositely inclined (see FIGS. 4 and 5) and each having, in the position of use and relative to the direction of movement of the items, a low upstream end 210a-220a and a high downstream end 210b-220b.

The two belt conveyors 210-220 are connected by:
a belt third conveyor 230 arranged between the high downstream end 210b of the belt first conveyor 210 and the low upstream end 220a of the belt second conveyor, and
a belt fourth conveyor 240 arranged between the high downstream end 220b of the belt second conveyor 220 and the low upstream end 210a of the belt first conveyor 210.

The number and the arrangement of the belt conveyors of a drying system according to the invention are chosen, in particular, as a function of the space available in the factory manufacturing the items.

A configuration like that from FIGS. 3a and 3b enables limitation of the overall size whilst optimizing the distance over which the items to be dried circulate relative to the FIG. 1 configuration with three conveyors.

In a variant that is not shown, the belt third conveyor 230 and the belt fourth conveyor 240 may equally be oppositely inclined so that during a cycle each item is dropped four times.

The drying system 200 also comprises a feeder belt conveyor 250 arranged at a low upstream end of one of the belt conveyors of the closed circuit, here the conveyor 210, to feed said circuit with items to be dried in the feed direction of the arrow F8.

In FIG. 3a the system is conformed for the entry of the items into the closed circuit of belt conveyors.

The items enter the conveyor 210 in the direction of the arrow F8 and then circulate along the conveyor 210 in the direction of the arrow F9.

They drop onto the conveyor 230 in the direction of the arrow F10 (see also FIG. 4) and then onto the conveyor 220 in the direction of the arrow F11. They then circulate along the conveyor 220 in the direction of the arrow F12. They then drop onto the conveyor 240 in the direction of the arrow F13 and then onto the conveyor 210 in the direction of the arrow F14 in order to be recirculated.

The items to be dried are then left to circulate in the closed circuit of belt conveyors for a number of cycles sufficient for the items to reach a threshold moisture content.

When the latter is reached, the dry articles must be evacuated from the circuit to continue the manufacturing process.

FIG. 3b shows the configuration of the drying system according to the invention for the items to exit.

In this figure, an exit belt conveyor 260 is activated by positioning it in the direction of the arrow F15 facing the high downstream end 220b of the belt conveyor 220 so that it intercepts the flow of items and the latter do not drop onto the belt conveyor 240.

Of course, activating the exit conveyor also includes starting it up so that it evacuates the items in the direction of the arrow F16 out of the closed circuit.

In the embodiment shown in FIGS. 3a to 5 the downstream end of each conveyor 210, 220, 230, 240 forms an angle (here approximately 45 degrees) with the sides of each conveyor, allowing good distribution of the items over the length of the next belt conveyor in the closed circuit.

In the embodiment shown in FIGS. 6a to 8, the downstream end 310b, 320b, 330b, 340b of each conveyor 310, 320, 330, 340 of the system 300 is perpendicular to the sides of each conveyor. Likewise, the upstream end of the exit belt conveyor 360 is perpendicular to the sides of said conveyor. The feeder conveyor 350 is identical to that of the previous embodiments.

To cause the items to drop from one conveyor onto another in the direction of the arrows F10, F11, F13 and F14 the downstream end 310b, 320b, 330b, 340b of each conveyor is disposed above and substantially in the middle of the next conveyor.

In order for the items to exit (FIGS. 6b and 8) the exit belt conveyor 360 is activated by positioning it in the direction of the arrow F15 facing the high downstream end 320b of the belt conveyor 320 so that it intersects the stream of items and the latter do not drop onto the belt conveyor 340.

The remainder of the operation of this embodiment is similar to that shown in FIGS. 3a to 5.

Although the distribution of the items on the next belt conveyor in the closed circuit is more linear than in the embodiment from FIGS. 3a to 5 the embodiment shown in FIGS. 6a to 8 is less complicated to implement and less costly. Moreover, the vibration generated by the vibrators 70 (not shown in these figures for clarity) enables the items to be at least partially spread out.

An alternative embodiment is shown in FIGS. 9a and 9b.

In this embodiment the drying system 400 according to the invention comprises four belt conveyors 410, 420, 430, 440 for the closed circuit, a feeder conveyor 450 and an exit conveyor 460 at the ends 410b, 420b, 430b, 440b, 450b, 460a perpendicular to the edges, as in the previous embodiment.

In the embodiment from FIGS. 9a and 9b, the downstream ends 410b, 430b-440b are each provided with a deflector 470 that diverts the stream of items from one conveyor to another.

The downstream end 420b of the belt conveyor 420 is provided with a deflector 480 pivoting in the direction of the arrow F17 between two positions of use: a first position shown in FIG. 9a enabling diversion of the stream of items from the conveyor 420 to the conveyor 440 to recirculate the items and a second position shown in FIG. 9b parallel to the stream of items and allowing the latter to rejoin the exit conveyor 460 in the direction of the arrow F16.

The embodiment from FIGS. 10a and 10b is a variant of that shown in FIGS. 6a and 6b. Identical parts in these figures have identical reference numbers.

Accordingly, the drying system 500 comprises four belt conveyors 310, 520, 330 and 340 arranged to form a closed circuit.

The downstream end 310b, 330b, 340b of each conveyor 310, 330, 340 is perpendicular to the sides of each conveyor.

The belt second conveyor 520 has a length greater than that of the belt first conveyor 310 and comprises, facing the belt fourth conveyor 340, a deflector 580 pivoting in the direction of the arrow F17 between two positions of use: a first position shown in FIG. 10a allowing diversion of the stream of items from the conveyor 520 to the conveyor 340 for recirculation of the items and a second position shown in FIG. 10b parallel to the stream of items and allowing the latter to rejoin the downstream end 520b of the conveyor 520 in the direction of the arrow F16.

Accordingly, in this variant, the downstream part 521 of the conveyor 520 situated between the pivoting deflector 580 and the downstream end 520b provides the exit conveyor function.

This part 521, arranged toward the downstream end of the conveyor 520, can be selectively activated thanks to the pivoting deflector 580 so as, when it is activated, to allow the items to exit the closed circuit.

This variant is equally applicable to the embodiment shown in FIGS. 9a and 9b.

The remainder of the operation of this embodiment is similar to that shown in FIGS. 3a to 5.

FIGS. 11a and 11b show a particularly advantageous embodiment of a drying system 600 according to the invention.

The system comprises two rigid chute conveyors 610-620 and two belt conveyors 630-640 arranged in such a manner as to constitute a closed circuit of conveyors to provide, in use, cyclic circulation of items disposed on the conveyors.

The rigid chute conveyors 610-620 are inclined in such a manner that, in use, items drop from a rigid chute conveyor 610-620 onto a belt conveyor 630-640.

Accordingly, the rigid chute first conveyor 610 and the rigid chute second conveyor 620 are oppositely inclined and each therefore has, in the position of use and relative to the direction of movement of the items, a low upstream end 610a-620a and a high downstream end 610b-620b.

The belt third conveyor 630 is arranged between the high downstream end 610b of the rigid chute first conveyor 610 and the low downstream end 620a of the rigid chute second conveyor 620.

Likewise, the belt fourth conveyor 640 is arranged between the high downstream end 620b of the rigid chute second conveyor 620 and the low upstream end 610a of the rigid chute first conveyor 610.

In an embodiment that is not shown, the belt conveyors 630-640 can also be inclined oppositely so that their downstream end is higher than their upstream end so that during a cycle each item drops four times.

This arrangement enables the installation to take up less space in the vertical direction whilst ensuring that the items drop between conveyors.

In this embodiment, the system also comprises an exit conveyor 650 that is selectively activatable at a downstream end 640b of one of the conveyors of the closed circuit, here the belt conveyor 640, in such a manner as, when it is activated, to allow items to exit the closed circuit.

In this embodiment the belt conveyor 640 is a reversible belt conveyor, that is to say the belt can be driven in two opposite directions. For example it comprises a drive motor that can be controlled so as to reverse the direction in which the belt is driven.

In this way, the items can be driven selectively either toward the rigid chute conveyor 610 (in the direction of the arrows F13 and F14) or toward the exit conveyor 650 (in the direction of the arrows F18 and F19).

As in the previous embodiments, a feeder conveyor 650 is arranged at an upstream end 610a of the conveyor 610 of the closed circuit to feed said closed circuit with items to be dried.

According to the invention, a plurality of vibrators 670 are arranged in such a manner as to cause the rigid chute conveyors 610-620 to vibrate with a defined vibration amplitude and frequency. The vibrators 670 preferably have an adjustable vibration amplitude and frequency.

In this embodiment, the vibrators 670 are arranged to generate also a vibration in a direction parallel to the longitudinal direction of the rigid chute conveyors, represented by the arrows F9 and F12.

Accordingly, the frequency and the amplitude of the vibration in the direction F9-F12 (substantially parallel to the longitudinal directions F9, F12 of the rigid chute conveyors) and of the vibration in the direction F7 (substantially perpendicular to the longitudinal direction F9, F12) are chosen so that the resulting vibration causes the items to advance toward the high downstream end 610b-620b whilst being turned over and shaken against one another.

Such vibrators are for example motors associated with one or more eccentrics.

In this embodiment with rigid chutes, the vibrators 670 therefore provide both the vibration function but also the function of driving the items along the rigid chute conveyors 610-620, in an unusual direction as the items rise toward the downstream end. Thanks to this additional constraint, the items are mixed for longer along each rigid chute conveyor 616-620 and drop from a relatively great height onto the belt conveyors 630-640, which mixes them further.

As in the other embodiments described above, the heating means (not shown) are arranged above the conveyors of the closed circuit, in particular, in this embodiment, above the rigid chute conveyors 610-620, to dry the items disposed on said conveyors.

The rigid chute conveyors generally comprise a rigid metal, preferably stainless steel, advantageously perforated, sheet on which the items move. This sheet is more resistant to the heating means than belts, were they made of metal trellis.

Another advantage resides in the possibility of connecting the sheet directly to one or more flexible suction pipes of an aspiration means (not shown), which significantly improves the quality of aspiration of dust and ambient moisture.

FIG. 11a shows partially and in a simplified diagrammatic manner a fifth embodiment during drying, that is to say when the items to be dried are circulating in the closed circuit of conveyors 610-620-630-640.

A defined number of items are introduced into the closed circuit by an entry conveyor 350 which deposits the items at the upstream end 610a of the rigid chute conveyor 610. The latter is vibrated by vibrators 670 adjusted so that the vibration generates a general movement in translation (arrow F9) of the items toward the top of the conveyor (the downstream end 610b). Over and above this general movement in translation, each item is also turned over and rubbed against the other items, which enables both rapid drying and effective and gentle polishing (greatly reducing the risk of breakages).

Reaching the downstream end 610b of the conveyor 610, the items drop onto the belt conveyor 630 (arrow F10) which drives them to the upstream end 620a where they drop again (arrow F11).

As on the conveyor 610, the items are moved in general translation (arrow F12) on the rigid chute second conveyor 620 toward the downstream end 620b by the vibrations of the vibrators 670.

There they drop onto the belt conveyor 640 (arrow F13) which drives them toward the upstream end 610a of the rigid chute first conveyor 610 onto which they drop again (arrow F15).

The circulation of the items then resumes if they are not dry, that is to say do not have a moisture content less than or equal to a threshold value.

When that moisture content is reached (it is preferably measured by a moisture sensor 90) the items are considered dry and can exit the drying system.

Their exit is shown in FIG. 11b in which the direction in which the belt conveyor 640 is driven is reversed.

The items present on or dropping onto the conveyor 640 are then driven toward the exit conveyor 650 (arrow F18) onto which they drop (arrow F19). The exit conveyor also being activated, the items are driven by it (arrow F20) toward the remainder of the installation for finishing the items.

As in the other embodiments, the drying system 600 is automated. It can therefore advantageously comprise a central unit 110 connected:
to a sensor 90 of the moisture content of the items disposed on the conveyors;
to the heating means; and/or
to a timer 120; and/or
to the aspiration means; and/or
to the vibrators 670.

The central unit 110 is then programmed:
to compare a moisture content value transmitted by the moisture sensor to a moisture content threshold value;
to command activation of the exit conveyor 650 if the moisture content value transmitted by the moisture sensor is less than or equal to the moisture content threshold value.

In the embodiment from FIGS. 11a and 11b activation of the exit conveyor 650 consists not only in actuating the exit conveyor 650 but also in reversing the direction in which the conveyor 640 is driven relative to the direction in which it is driven when drying the items (FIG. 11a).

To this end, the central unit is also connected to the drive motor of the belt conveyor 640 and programmed in such a manner as to be able to actuate the exit conveyor and to reverse the direction in which the belt conveyor 640 is driven if the moisture content value transmitted by the sensor is less than or equal to the threshold value so that the items leave the rigid chute conveyor 620 by dropping onto the belt conveyor driven in the reverse direction to direct the items toward the exit conveyor 650 (direction of the arrows F18 and F19; see FIG. 11b) which directs them toward the remainder of the installation for the end of the manufacturing process (direction of the arrow F20; see FIG. 11b).

As in the other embodiments, the central unit 110 is also programmed:
to time a time of presence of the items in the closed circuit of conveyors;
to control the heating means as a function of the moisture content value transmitted by the moisture sensor 90 and the time of presence transmitted by the timer 120 in order to regulate an item drying time;
to control the vibrators 670 by modifying the frequency and/or the amplitude of vibration of the vibrators 670 as a function of the moisture content value transmitted by the moisture sensor 90 to control a drive speed of the rigid chute conveyors.

Thus the invention proposes a new method of drying wood items for the agriculture-foodstuffs industry comprising the following steps:
A) arranging at least three conveyors such a manner as to constitute a closed circuit of conveyors to provide, in use, cyclic circulation of items disposed on these conveyors, at least one of the conveyors advantageously being inclined in such a manner that, in use, the items drop from one conveyor onto another;
B) arranging a so-called “exit” conveyor that can be activated in a selective manner at a downstream end of one of the conveyors of the closed circuit in such a manner as to allow, when it is activated, the items to exit the closed circuit;
C) arranging a plurality of vibrators to cause the conveyors to vibrate, in use, with a defined frequency and a defined amplitude of vibration;
D) arranging heating means above the conveyors of the closed circuit to dry, in use, the items deposited on the conveyors;
E) actuating the vibrators and the conveyors of the closed circuit;
F) actuating the heating means;
G) feeding one of the conveyors with a defined quantity of items to be dried;
H) allowing the items to be dried to circulate on the closed circuit of conveyors for a number of cycles sufficient for the items to reach a threshold moisture content;
J) activating the exit conveyor in such a manner as to allow the dried items to exit the closed circuit.

The method advantageously comprises between the step H) and the step J) a step I) of activating nozzles for spraying solid or liquid paraffin wax onto the items in order to coat the dry items with paraffin wax.

Drying the items on conveyors limits the thickness of the mass of items, which accelerates drying. This also limits the weight supported by the items situated at the bottom and the force of the impacts to which each item is subjected, which reduces the number of items broken and the losses of raw material and paraffin wax.

According to embodiments that are not shown:
the edges of the conveyors may be provided with a skirt to prevent the items falling out of them;
to improve the spreading of the items across the width of the conveyors, in particular, but not exclusively in the embodiments from FIGS. 6a-6b and 10a-10b, it is possible to dispose above each conveyor a gantry, preferably provided with a flexible strip or chains, arranged at a distance sufficient to spread the items whilst allowing them to pass once spread;
it is possible to insert into the closed circuit of conveyors a sorting module to eliminate broken items; this module advantageously comprises sensors connected to an image analyser itself connected to mechanical separators enabling broken items to be diverted to an evacuation exit;
the conveyors may be perforated rigid chute conveyors in which the aspiration means is situated under the rigid chute conveyors relative to the items; and/or
the rigid chute conveyors may be constituted of a metal mesh.

1. System (100, 200, 300, 400, 500, 600) for drying wood items for the agriculture-foodstuffs industry characterized in that it comprises:
at least three conveyors (10, 20, 30, 210, 220, 230, 240, 310, 320, 330, 340, 410, 420, 430, 440, 520, 610, 620, 630, 640) arranged in such a manner as to constitute a closed circuit of conveyors to provide, in use, cyclic circulation of items disposed on these conveyors, at least one of the conveyors being inclined in such a manner that, in use, the items drop from one conveyor onto another;
a so-called “exit” conveyor (50, 260, 360, 460, 521, 650) that can be activated in a selective manner at a downstream end (220b, 320b, 420b, 620b) of one of the conveyors of the closed circuit in such a manner as to allow, when it is activated, the items to exit from the closed circuit;
a plurality of vibrators (70, 670) adapted to cause the conveyors (10, 20, 30, 210, 220, 230, 240, 310, 320, 330, 340, 410, 420, 430, 440, 520, 610, 620, 630, 640) to vibrate in a direction (F7) substantially perpendicular (13) to a longitudinal direction (F9, F12) of the rigid chute conveyors with a defined frequency and a defined amplitude of vibration;
heating means (60, 61) above the conveyors (10, 20, 30, 210, 220, 230, 240, 310, 320, 330, 340, 410, 420, 430, 440, 520, 610, 620, 630, 640) of the closed circuit to dry, in use, the items deposited on the conveyors.

2. Drying system according to claim 1 in which the vibrators (70, 670) have an adjustable frequency and an adjustable amplitude of vibration.

3. Drying system according to claim 1 in which the conveyors are chosen from belt conveyors, rigid chute conveyors and a mixture thereof.

4. Drying system according to claim 1 in which the closed circuit of conveyors comprises:
a rigid chute first conveyor (610) and a rigid chute second conveyor (620) oppositely inclined and therefore each having, in a position of use and relative to the direction of movement of the items, a low upstream end (610a, 620a) and a high downstream end (610b, 620b);
a belt third conveyor (630) arranged between the high downstream end (610b) of the rigid chute first conveyor (610) and the low upstream end (620a) of the rigid chute second conveyor (620);
a belt fourth conveyor (640) arranged between the high downstream end (620b) of the rigid chute second conveyor (620) and the low upstream end (610a) of the rigid chute first conveyor (610);
the vibrators being adapted also to generate a vibration in a direction substantially parallel to a longitudinal direction (F9, F12) of the rigid chute conveyors with a defined frequency and a defined amplitude of vibration.

5. Drying system according to claim 1 in which the closed circuit of conveyors comprises:
a belt first conveyor (210, 310, 410) and a belt second conveyor (220, 320, 420, 520) inclined oppositely and each therefore having, in the position of use and relative to the direction of movement of the items, a low upstream end (210a, 220a) and a high downstream end (210b, 220b, 310b, 320b, 410b, 420b, 520b);
a belt third conveyors (230, 330, 430) arranged between the high downstream end (210b, 310b, 410b) of the belt first conveyor (210, 310, 410) and the low upstream end (220a) of the belt second conveyor (220, 320, 420, 520);
a belt fourth conveyor (240, 340, 440) arranged between the high downstream end (220b, 320b, 420b) of the belt second conveyor (220, 320, 420, 520) and the low upstream end (210a) of the belt first conveyor (210, 310, 410).

6. Drying system according to claim 4 in which the belt third and fourth conveyors (230, 240, 330, 340, 430, 440, 630, 640) are also oppositely inclined so that during a cycle each item drops four times.

7. Drying system according to claim 1, further comprising:
a sensor (90) of the moisture content of the items disposed on the conveyors;
a central unit (110) connected to the moisture sensor (90) and programmed:
to compare a moisture content value transmitted by the moisture sensor (90) to a moisture content threshold value;
to command activation of the exit conveyor (50, 260, 360, 460, 521, 650) if the moisture content value transmitted by the moisture sensor (90) is less than or equal to the moisture content threshold value.

8. Drying system according to claim 7 in which the central unit (110) is also connected to a timer (120) and to the heating means (60-61), the central unit (110) being programmed:
to time a time of presence of the items on the closed circuit of conveyors;
to control the heating means (60-61) as a function of the moisture content value transmitted by the moisture sensor (90) and the time of presence transmitted by the timer (120) in order to regulate a drying time of the items.

9. Drying system according to claim 7 in which the central unit (110) is also connected to the vibrators (70, 670), the central unit being programmed to control the frequency and/or the amplitude of vibration of the vibrators (70, 670) as a function of the moisture content value transmitted by the moisture sensor (90).

10. Drying system according to claim 7 in which the conveyors of the closed circuit are belt conveyors, the central unit (110) being also connected to drive motors (M) of the belt conveyors (10, 20, 30, 210, 220, 230, 240, 310, 320, 330, 340, 410, 420, 430, 440, 520) and programmed to control a drive speed of the belt conveyors as a function of the moisture content value transmitted by the moisture sensor (90).

11. Drying system according to claim 1 further comprising a feeder conveyor (40, 250, 350, 450) arranged at an upstream end (210a, 610a) of one of the conveyors (210, 610) of the closed circuit to feed said closed circuit with items to be dried.

12. Drying system according to claim 1 in which the heating means (60) comprise a bank of infrared lamps (61).

13. Drying system according to claim 1 further comprising at least one ambient air aspiration means (80).

14. Drying system according to claim 13 in which the aspiration means (80) is situated beside and near the conveyors (10, 20, 30, 210, 220, 230, 240, 310, 320, 330, 340, 410, 420, 430, 440, 520).

15. Drying system according to claim 13 in which the conveyors are belt conveyors (10, 20, 30, 210, 220, 230, 240, 310, 320, 330, 340, 410, 420, 430, 440, 520) the belts of which are perforated and in which the aspiration means (80) is situated under the belt of the belt conveyors relative to the items.

16. Drying system according to claim 1 in which the conveyors are belt conveyors (10, 20, 30, 210, 220, 230, 240, 310, 320, 330, 340, 410, 420, 430, 440, 520) the belts of which are perforated and constituted of a metal mesh.

17. Drying system according to claim 13 in which the conveyors are perforated rigid chute conveyors (610, 620) and in which the aspiration means (80) is situated under the rigid chute conveyors relative to the items.

18. Drying system according to claim 17 in which the rigid chute conveyors (610, 620) are constituted of a metal mesh.

19. Method for drying wood items for the agriculture-foodstuffs industry using a drying system according to claim 1, characterized in that it comprises the following steps:
A) arranging at least three conveyors (10, 20, 30, 210, 220, 230, 240, 310, 320, 330, 340, 410, 420, 430, 440, 520, 610, 620, 630, 640) in such a manner as to constitute a closed circuit of conveyors to provide, in use, cyclic circulation of items disposed on these conveyors, at least one of the conveyors being inclined in such a manner that, in use, the items drop from one conveyor onto another;
B) arranging a so-called “exit” conveyor (50, 260, 360, 460, 521, 650) that can be activated in a selective manner at a downstream end (220b, 320b, 420b, 640b) of one of the conveyors of the closed circuit in such a manner as to allow, when it is activated, the items to exit from the closed circuit;
C) arranging a plurality of vibrators (70, 670) to cause at least one of the conveyors, in use, to vibrate with a defined frequency and a defined amplitude of vibration;
D) arranging heating means (60-61) above the conveyors (10, 20, 30, 210, 220, 230, 240, 310, 320, 330, 340, 410, 420, 430, 440, 520, 610, 620, 630, 640) to dry, in use, the items deposited on the conveyors;
E) actuating the vibrators (70, 670) and the conveyors (10, 20, 30, 210, 220, 230, 240, 310, 320, 330, 340, 410, 420, 430, 440, 520, 610, 620, 630, 640) of the closed circuit;
F) actuating the heating means (60-61);
G) feeding one of the conveyors (10, 210, 310, 410, 610) of the closed circuit of conveyors with a defined quantity of items to be dried;
H) allowing the items to be dried to circulate on the closed circuit of conveyors for a number of cycles sufficient for the items to reach a threshold moisture content;
J) activating the exit conveyor (50, 260, 360, 460, 521, 650) in such a manner as to allow the dried items to exit from the closed circuit.
